(19) United States
(12) Patent Application Publication
(10) Pub. No.: US 2026/0080324 A1
(43) Pub. Date: Mar. 19, 2026

(54) SYSTEMS AND METHODS FOR A RULES ENGINE WITHOUT HARDCODED RULES

(71) Applicant: Truist Bank, Charlotte, NC (US)

(72) Inventors: Glenn Pinto, Charlotte, NC (US); Niranjan Kumar Kandaswamy, Charlottte, NC (US)

(73) Assignee: Truist Bank, Charlotte, NC (US)

(21) Appl. No.: 18/887,143

(22) Filed: Sep. 17, 2024

(51) Int. Cl. G06Q 10/063; G06F 9/54; G06F 40/20

(52) U.S. Cl. CPC G06Q 10/063; G06F 9/54; G06F 40/20

(57) ABSTRACT

A method, computer program product, and computer system for configuring, by a computing device, a plurality of rules for use by a rules engine, wherein the plurality of rules may be written in a native language as expressions. Data may be extracted from a source. At least a portion of the data may be input into a plurality of input fields based upon, at least in part, the data extracted from the source. The plurality of rules may be run on at least the portion of the data populated into the plurality of input fields. A decision may be returned based upon, at least in part, running the plurality of rules on at least the portion of the data populated into the plurality of input fields.

### TECHNICAL FIELD

The present disclosure relates to data analysis, and more particularly, to a rules engine for performing customized data analysis without hardcoded rules.

### BACKGROUND

Artificial intelligence (AI) has become a valuable tool for addressing a wide range of technological needs. For instance, AI may help improve decision-making by providing deep insights from large volumes of data, helping businesses uncover valuable patterns and trends that might not be apparent through manual analysis.

### SUMMARY

In one example implementation, a computer-implemented method, performed by one or more computing devices, may include but is not limited to configuring, by a computing device, a plurality of rules for use by a rules engine, wherein the plurality of rules may be written in a native language as expressions. Data may be extracted from a source. At least a portion of the data may be input into a plurality of input fields based upon, at least in part, the data extracted from the source. The plurality of rules may be run on at least the portion of the data populated into the plurality of input fields. A decision may be returned based upon, at least in part, running the plurality of rules on at least the portion of the data populated into the plurality of input fields.

One or more of the following example features may be included. Multiple rules of the plurality of rules may be combined together into a set of rules with conditional operators. The rules are not hardcoded in an underlying codebase of the rules engine. The plurality of rules may be modifiable without changing an underlying codebase of the rules engine. An expression tree may evaluate and execute the expressions. Configuring the plurality of rules for use by the rules engine may include calling an Application Programming Interface (API) of a data store of the rules engine by a user interface (UI) of the rules engine. The API of the rules engine may extract the data from the source.

In another example implementation, a computing system may include one or more processors and one or more memories configured to perform operations that may include but are not limited to configuring, by a computing device, a plurality of rules for use by a rules engine, wherein the plurality of rules may be written in a native language as expressions. Data may be extracted from a source. At least a portion of the data may be input into a plurality of input fields based upon, at least in part, the data extracted from the source. The plurality of rules may be run on at least the portion of the data populated into the plurality of input fields. A decision may be returned based upon, at least in part, running the plurality of rules on at least the portion of the data populated into the plurality of input fields.

One or more of the following example features may be included. Multiple rules of the plurality of rules may be combined together into a set of rules with conditional operators. The rules are not hardcoded in an underlying codebase of the rules engine. The plurality of rules may be modifiable without changing an underlying codebase of the rules engine. An expression tree may evaluate and execute the expressions. Configuring the plurality of rules for use by the rules engine may include calling an Application Programming Interface (API) of a data store of the rules engine by a user interface (UI) of the rules engine. The API of the rules engine may extract the data from the source.

In another example implementation, a computer program product may reside on a computer readable storage medium having a plurality of instructions stored thereon which, when executed across one or more processors, may cause at least a portion of the one or more processors to perform operations that may include but are not limited to configuring, by a computing device, a plurality of rules for use by a rules engine, wherein the plurality of rules may be written in a native language as expressions. Data may be extracted from a source. At least a portion of the data may be input into a plurality of input fields based upon, at least in part, the data extracted from the source. The plurality of rules may be run on at least the portion of the data populated into the plurality of input fields. A decision may be returned based upon, at least in part, running the plurality of rules on at least the portion of the data populated into the plurality of input fields.

One or more of the following example features may be included. Multiple rules of the plurality of rules may be combined together into a set of rules with conditional operators. The rules are not hardcoded in an underlying codebase of the rules engine. The plurality of rules may be modifiable without changing an underlying codebase of the rules engine. An expression tree may evaluate and execute the expressions. Configuring the plurality of rules for use by the rules engine may include calling an Application Programming Interface (API) of a data store of the rules engine by a user interface (UI) of the rules engine. The API of the rules engine may extract the data from the source.

The details of one or more example implementations are set forth in the accompanying drawings and the description below. Other possible example features and/or possible example advantages will become apparent from the description, the drawings, and the claims. Some implementations may not have those possible example features and/or possible example advantages, and such possible example features and/or possible example advantages may not necessarily be required of some implementations.

### DRAWINGS

FIG. 1 is an example diagrammatic view of a rules process coupled to an example distributed computing network according to one or more example implementations of the disclosure;

FIG. 2 is an example diagrammatic view of a client electronic device of FIG. 1 according to one or more example implementations of the disclosure;

FIG. 3 is an example flowchart of a rules process according to one or more example implementations of the disclosure;

FIG. 4 is an example process flow of a rules process according to one or more example implementations of the disclosure;

FIG. 5 is an example diagrammatic view of an example user interface according to one or more example implementations of the disclosure;

FIG. 6 is an example diagrammatic view of an example logical data model according to one or more example implementations of the disclosure;

FIG. 7 is an example high level logical architecture diagram according to one or more example implementations of the disclosure; and

FIG. 8 is an example workflow of a rules process according to one or more example implementations of the disclosure.

Like reference symbols in the various drawings indicate like elements.

### DESCRIPTION

### System Overview

In some implementations, the present disclosure may be embodied as a method, system, or computer program product. Accordingly, in some implementations, the present disclosure may take the form of an entirely hardware implementation, an entirely software implementation (including firmware, resident software, micro-code, etc.) or an implementation combining software and hardware aspects that may all generally be referred to herein as a “circuit,” “module” or “system.” Furthermore, in some implementations, the present disclosure may take the form of a computer program product on a computer-usable storage medium having computer-usable program code embodied in the medium.

Software may include artificial intelligence (AI) systems, which may include machine learning or other computational intelligence. For example, AI may include one or more models used for one or more problem domains. When presented with many data features, identification of a subset of features that are relevant to a problem domain may improve prediction accuracy, reduce storage space, and increase processing speed. This identification may be referred to as feature engineering. Feature engineering may be performed by users or may only be guided by users. In various implementations, a machine learning system may computationally identify relevant features, such as by performing singular value decomposition on the contributions of different features to outputs.

In some implementations, the various computing devices may include, integrate with, link to, exchange data with, be governed by, take inputs from, and/or provide outputs to one or more AI systems, which may include models, rule-based systems, expert systems, neural networks, deep learning systems, supervised learning systems, robotic process automation systems, natural language processing systems, intelligent agent systems, self-optimizing and self-organizing systems, and others. Except where context specifically indicates otherwise, references to AI, or to one or more examples of AI, should be understood to encompass one or more of these various alternative methods and systems; for example, without limitation, an AI system described for enabling any of a wide variety of functions, capabilities and solutions described herein (such as optimization, autonomous operation, prediction, control, orchestration, or the like) should be understood to be capable of implementation by operation on a model or rule set; by training on a training data set of human tag, labels, or the like; by training on a training data set of human interactions (e.g., human interactions with software interfaces or hardware systems); by training on a training data set of outcomes; by training on an AI-generated training data set (e.g., where a full training data set is generated by AI from a seed training data set); by supervised learning; by semi-supervised learning; by deep learning; or the like. For any given function or capability that is described herein, neural networks of various types may be used, including any of the types described herein, and in embodiments a hybrid set of neural networks may be selected such that within the set a neural network type that is more favorable for performing each element of a multi-function or multi-capability system or method is implemented. As one example among many, a deep learning, or black box, system may use a gated recurrent neural network for a function like language translation for an intelligent agent, where the underlying mechanisms of AI operation need not be understood as long as outcomes are favorably perceived by users, while a more transparent model or system and a simpler neural network may be used for a system for automated governance, where a greater understanding of how inputs are translated to outputs may be needed to comply with regulations or policies.

Examples of the models (e.g., AI-based models) include recurrent neural networks (RNNs) such as long short-term memory (LSTM), deep learning models such as transformers, decision trees, support-vector machines, genetic algorithms, Bayesian networks, and regression analysis. Examples of systems based on a transformer model include bidirectional encoder representations from transformers (BERT) and generative pre-trained transformers (GPT). Training a machine-learning model (or other type of AI-based learning models) may include supervised learning (for example, based on labelled input data), unsupervised learning, and reinforcement learning. In various embodiments, a machine-learning model may be pre-trained by their operator or by a third party. Problem domains include nearly any situation where structured data can be collected, and includes natural language processing (NLP), including natural language understanding (NLU), computer vision (CV), classification, image recognition, etc. Some or all of the software may run in a virtual environment rather than directly on hardware. The virtual environment may include a hypervisor, emulator, sandbox, container engine, etc. The software may be built as a virtual machine, a container, etc. Virtualized resources may be controlled using, for example, a DOCKER container platform, a pivotal cloud foundry (PCF) platform, etc. Some or all of the software may be logically partitioned into microservices. Each microservice offers a reduced subset of functionality. In various embodiments, each microservice may be scaled independently depending on load, either by devoting more resources to the microservice or by instantiating more instances of the microservice. In various embodiments, functionality offered by one or more microservices may be combined with each other and/or with other software not adhering to a microservices model.

In some implementations, as noted above, AI-based learning models may include at least one of a transformer model, a convolutional neural network, a deep learning model trained on a set of outcomes of the value chain network entity, a supervised model, a semi-supervised model, an unsupervised model, or a reinforcement model, and the training data set for the AI-based learning models may include one or a set of objects or events that are labeled to classify the set of objects or events according to a classification taxonomy. Other examples of AI-based learning models (e.g., machine learning models) may include neural networks in general (e.g., deep neural networks, convolution neural networks, and many others), regression-based models, decision trees, hidden forests, Hidden Markov models, Bayesian models, and the like. In some implementations, the present disclosure may include combinations where an expert system uses one neural network for classifying an item and a different (or the same) neural network for predicting a state of the item.

In some implementations, any suitable computer usable or computer readable medium (or media) may be utilized. The computer readable medium may be a computer readable signal medium or a computer readable storage medium. The computer-usable, or computer-readable, storage medium (including a storage device associated with a computing device or client electronic device) may be, for example, but is not limited to, an electronic, magnetic, optical, electromagnetic, infrared, or semiconductor system, apparatus, device, or any suitable combination of the foregoing. More specific examples (a non-exhaustive list) of the computer-readable medium or storage device may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, solid state drives (SSDs), a digital versatile disk (DVD), a Blu-ray disc, and an Ultra HD Blu-ray disc, a static random access memory (SRAM), dynamic RAM (DRAM), synchronous DRAM (SDRAM), synchronous graphics RAM (SGRAM), and video RAM (VRAM), analog magnetic tape, digital magnetic tape, rotating hard disk drive (HDDs), a memory stick, a floppy disk, a mechanically encoded device such as punch-cards or raised structures in a groove having instructions recorded thereon, a media such as those supporting the internet or an intranet, or a magnetic storage device. Note that the computer-usable or computer-readable medium could even be a suitable medium upon which the program is stored, scanned, compiled, interpreted, or otherwise processed in a suitable manner, if necessary, and then stored in a computer memory. In the context of the present disclosure, a computer-usable or computer-readable, storage medium may be any tangible medium that can contain or store a program for use by or in connection with the instruction execution system, apparatus, or device.

Examples of storage implemented by the storage hardware include a distributed ledger, such as a permissioned or permissionless blockchain. Entities recording transactions, such as in a blockchain, may reach consensus using an algorithm such as proof-of-stake, proof-of-work, and proof-of-storage. Elements of the present disclosure may be represented by or encoded as non-fungible tokens (NFTs). Ownership rights related to the non-fungible tokens may be recorded in or referenced by a distributed ledger. Transactions initiated by or relevant to the present disclosure may use one or both of fiat currency and cryptocurrencies, examples of which include bitcoin and ether.

In some implementations, a computer readable signal medium may include a propagated data signal with computer readable program code embodied therein, for example, in baseband or as part of a carrier wave. In some implementations, such a propagated signal may take any of a variety of forms, including, but not limited to, electro-magnetic, optical, or any suitable combination thereof. In some implementations, the computer readable program code may be transmitted using any appropriate medium, including but not limited to the internet, wireline, optical fiber cable, RF, etc. In some implementations, a computer readable signal medium may be any computer readable medium that is not a computer readable storage medium and that can communicate, propagate, or transport a program for use by or in connection with an instruction execution system, apparatus, or device.

In some implementations, computer program code for carrying out operations of the present disclosure may be assembler instructions, instruction-set-architecture (ISA) instructions, machine instructions, machine dependent instructions, microcode, firmware instructions, state-setting data, state information that personalizes electronic circuitry and/or other structural components that are native to hardware (e.g., host processor, central processing unit/CPU, microcontroller, etc.) or either source code or object code written in any combination of one or more programming languages, including an object oriented programming language such as Java®, Smalltalk, C++ or the like. Java® and all Java-based trademarks and logos are trademarks or registered trademarks of Oracle and/or its affiliates. However, the computer program code for carrying out operations of the present disclosure may also be written in conventional procedural programming languages, such as the “C” programming language, PASCAL, or similar programming languages, as well as in scripting languages such as JavaScript, PERL, or Python. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a network, such as a cellular network, local area network (LAN), a wide area network (WAN), a body area network BAN), a personal area network (PAN), a metropolitan area network (MAN), etc., or the connection may be made to an external computer (for example, through the internet using an Internet Service Provider). The networks may include one or more of point-to-point and mesh technologies. Data transmitted or received by the networking components may traverse the same or different networks. Networks may be connected to each other over a WAN or point-to-point leased lines using technologies such as Multiprotocol Label Switching (MPLS) and virtual private networks (VPNs), etc. In some implementations, electronic circuitry including, for example, programmable logic circuitry, an application specific integrated circuit (ASIC), gate arrays such as field-programmable gate arrays (FPGAs) or other hardware accelerators, micro-controller units (MCUs), or programmable logic arrays (PLAs), integrated circuits (ICs), digital circuit elements, analog circuit elements, combinational logic circuits, digital signal processors (DSPs), complex programmable logic devices (CPLDs), memory chips, network chips, systems on chip (SoCs), SSD/NAND controller ASICs, and the like, etc. may execute the computer readable program instructions/code by utilizing state information of the computer readable program instructions to personalize the electronic circuitry, in order to perform aspects of the present disclosure. Configurable or fixed-functionality logic may be implemented with complementary metal oxide semiconductor (CMOS) logic circuits, transistor-transistor logic (TTL) logic circuits, or other circuits. Multiple components of the hardware may be integrated, such as on a single die, in a single package, or on a single printed circuit board or logic board. For example, multiple components of the hardware may be implemented as a system-on-chip. A component, or a set of integrated components, may be referred to as a chip, chipset, chiplet, or chip stack. Examples of a system-on-chip include a radio frequency (RF) system-on-chip, an AI system-on-chip, a video processing system-on-chip, an organ-on-chip, a quantum algorithm system-on-chip, etc.

Examples of processing hardware may include, e.g., a central processing unit (CPU), a graphics processing unit (GPU), an accelerator (e.g., an AI accelerator), an approximate computing processor, a quantum computing processor, a parallel computing processor, a neural network processor, a signal processor, a digital processor, an analog processor, a data processor, an embedded processor, a microprocessor, and a co-processor. The co-processor may provide additional processing functions and/or optimizations, such as for speed or power consumption. Examples of a co-processor include a math co-processor, a graphics co-processor, a communication co-processor, a video co-processor, and an AI co-processor.

In some implementations, the AI accelerator may include suitable logic, circuitry, and/or interfaces to accelerate artificial intelligence applications, such as, e.g., artificial neural networks, machine vision and machine learning applications, including through parallel processing techniques. In one or more examples, the AI accelerator may include hardware logic or devices such as, e.g., a GPU or an FPGA. The AI accelerator may be used with any of the devices, components, features or methods described herein.

In some implementations, the flowchart and block diagrams in the figures illustrate the architecture, functionality, and operation of possible implementations of apparatus (systems), methods and computer program products according to various implementations of the present disclosure. Each block in the flowchart and/or block diagrams, and combinations of blocks in the flowchart and/or block diagrams, may represent a module, segment, or portion of code, which comprises one or more executable computer program instructions for implementing the specified logical function(s)/act(s). These computer program instructions may be provided to a processor of a general purpose computer, special purpose computer, or other programmable data processing apparatus to produce a machine, such that the computer program instructions, which may execute via the processor of the computer or other programmable data processing apparatus, create the ability to implement one or more of the functions/acts specified in the flowchart and/or block diagram block or blocks or combinations thereof. It should be noted that, in some implementations, the functions noted in the block(s) may occur out of the order noted in the figures (or combined or omitted). For example, two blocks shown in succession may, in fact, be executed substantially concurrently, or the blocks may sometimes be executed in the reverse order, depending upon the functionality involved. In addition, in some of the drawings, signal conductor lines may be represented with lines. Some may be different, to indicate more constituent signal paths, have a number label, to indicate a number of constituent signal paths, and/or have arrows at one or more ends, to indicate primary information flow direction(s). This, however, should not be construed in a limiting manner. Rather, such added detail may be used in connection with one or more implementations to facilitate ease of understanding. Any represented lines, whether or not having additional information, may actually comprise one or more signals/information that may travel in multiple directions and may be implemented with any suitable type of signal scheme, e.g., digital or analog lines implemented with differential pairs, optical fiber lines, and/or single-ended lines, etc.

In some implementations, these computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks or combinations thereof.

In some implementations, the computer program instructions may also be loaded onto a computer or other programmable data processing apparatus to cause a series of operational steps to be performed (not necessarily in a particular order) on the computer or other programmable apparatus to produce a computer implemented process such that the instructions which execute on the computer or other programmable apparatus provide steps for implementing the functions/acts (not necessarily in a particular order) specified in the flowchart and/or block diagram block or blocks or combinations thereof.

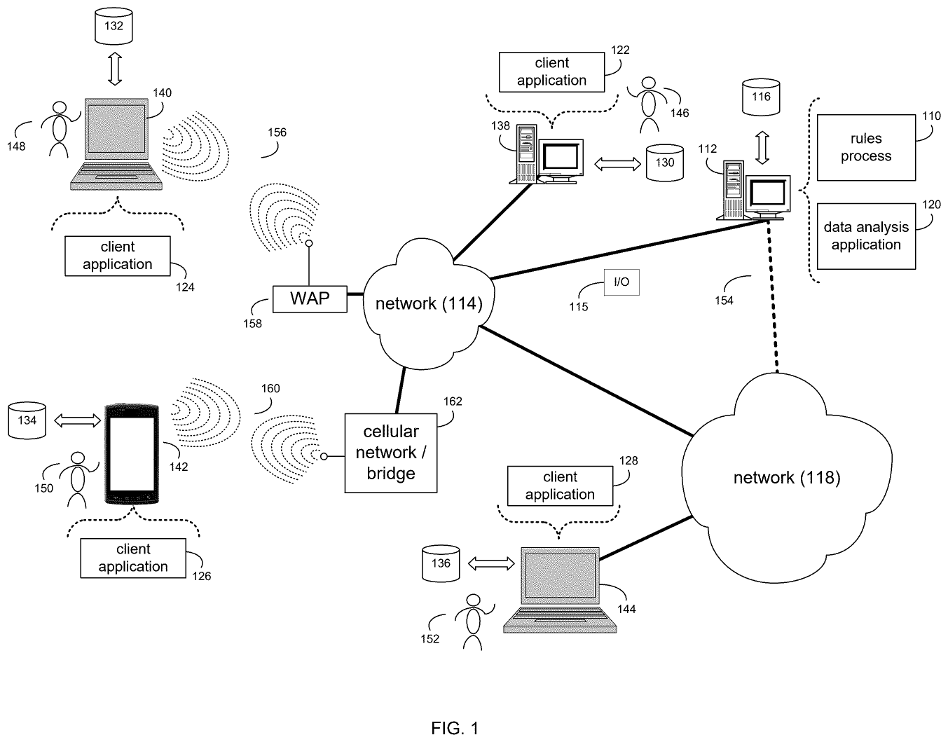

Referring now to the example implementation of FIG. 1, there is shown rules process 110 that may reside on and may be executed by a computer (e.g., computer 112), which may be connected to a network (e.g., network 114) (e.g., the internet or a local area network). Examples of computer 112 (and/or one or more of the client electronic devices noted below) may include, but are not limited to, a storage system (e.g., a Network Attached Storage (NAS) system, a Storage Area Network (SAN)), a personal computer(s), a laptop computer(s), mobile computing device(s), a server computer, a series of server computers, a mainframe computer(s), or a computing cloud(s). A SAN may include one or more of the client electronic devices, including a RAID device and a NAS system. In some implementations, each of the aforementioned may be generally described as a computing device. In certain implementations, a computing device may be a physical or virtual device. In many implementations, a computing device may be any device capable of performing operations, such as a dedicated processor, a portion of a processor, a virtual processor, a portion of a virtual processor, portion of a virtual device, or a virtual device. In some implementations, a processor may be a physical processor or a virtual processor. In some implementations, a virtual processor may correspond to one or more parts of one or more physical processors. In some implementations, the instructions/logic may be distributed and executed across one or more processors, virtual or physical, to execute the instructions/logic. Computer 112 may execute an operating system, for example, but not limited to, Microsoft® Windows®; Mac® OS X®; Red Hat® Linux®, Windows® Mobile, Chrome OS, Blackberry OS, Fire OS, or a custom operating system. (Microsoft and Windows are registered trademarks of Microsoft Corporation in the United States, other countries or both; Mac and OS X are registered trademarks of Apple Inc. in the United States, other countries or both; Red Hat is a registered trademark of Red Hat Corporation in the United States, other countries or both; and Linux is a registered trademark of Linus Torvalds in the United States, other countries or both).

In some implementations, as will be discussed below in greater detail, a rules process, such as rules process 110 of FIG. 1, may configure, by a computing device, a plurality of rules for use by a rules engine, wherein the plurality of rules may be written in a native language as expressions. Data may be extracted from a source. At least a portion of the data may be input into a plurality of input fields based upon, at least in part, the data extracted from the source. The plurality of rules may be run on at least the portion of the data populated into the plurality of input fields. A decision may be returned based upon, at least in part, running the plurality of rules on at least the portion of the data populated into the plurality of input fields.

In some implementations, the instruction sets and subroutines of rules process 110, which may be stored on storage device, such as storage device 116, coupled to computer 112, may be executed by one or more processors and one or more memory architectures included within computer 112. In some implementations, storage device 116 may include but is not limited to: a hard disk drive; all forms of flash memory storage devices; a tape drive; an optical drive; a RAID array (or other array); a random access memory (RAM); a read-only memory (ROM); or combination thereof. In some implementations, storage device 116 may be organized as an extent, an extent pool, a RAID extent (e.g., an example 4D+1P R5, where the RAID extent may include, e.g., five storage device extents that may be allocated from, e.g., five different storage devices), a mapped RAID (e.g., a collection of RAID extents), or combination thereof.

In some implementations, network 114 may be connected to one or more secondary networks (e.g., network 118), examples of which may include but are not limited to: a local area network; a wide area network or other telecommunications network facility; or an intranet, for example. The phrase “telecommunications network facility,” as used herein, may refer to a facility configured to transmit, and/or receive transmissions to/from one or more mobile client electronic devices (e.g., cellphones, etc.) as well as many others.

In some implementations, computer 112 may include a data store, such as a database (e.g., relational database, object-oriented database, triplestore database, etc.), a data store, a data lake, a column store, and/or a data warehouse, and may be located within any suitable memory location, such as storage device 116 coupled to computer 112. In some implementations, data, metadata, information, etc. described throughout the present disclosure may be stored in the data store. In some implementations, computer 112 may utilize any known database management system such as, but not limited to, DB2, in order to provide multi-user access to one or more databases, such as the above noted relational database. In some implementations, the data store may also be a custom database, such as, for example, a flat file database or an XML database. In some implementations, any other form(s) of a data storage structure and/or organization may also be used. In some implementations, rules process 110 may be a component of the data store, a standalone application that interfaces with the above noted data store and/or an applet/application that is accessed via client applications 122, 124, 126, 128. In some implementations, the above noted data store may be, in whole or in part, distributed in a cloud computing topology. In this way, computer 112 and storage device 116 may refer to multiple devices, which may also be distributed throughout the network.

In some implementations, computer 112 may execute a data analysis application (e.g., data analysis application 120), examples of which may include, but are not limited to, e.g., an automatic speech recognition (ASR) application, examples of which may include, but are not limited to, e.g., an automatic speech recognition (ASR) application (e.g., modeling, transcription, etc.), a natural language understanding (NLU)/natural language processing (NLP) application (e.g., machine learning, intent discovery, etc.), a text to speech (TTS) application (e.g., context awareness, learning, etc.), a speech signal enhancement (SSE) application (e.g., multi-zone processing/beamforming, noise suppression, etc.), a voice biometrics/wake-up-word processing application, a predictive analytics application, a machine learning application, an automated underwriting system application, a risk assessment application, a fraud detection application, a customer segmentation and profiling application, a data integration and processing application, a web conferencing application, a video conferencing application, a telephony application, a voice-over-IP application, a video-over-IP application, an Instant Messaging (IM)/“chat” application, a chatbot application, an interactive voice response (IVR) application, a short messaging service (SMS)/multimedia messaging service (MMS) application, or other application that allows for AI based analysis and/or decision making. In some implementations, rules process 110 and/or data analysis application 120 may be accessed via one or more of client applications 122, 124, 126, 128. In some implementations, rules process 110 may be a standalone application, or may be an applet/application/script/extension that may interact with and/or be executed within data analysis application 120, a component of data analysis application 120, and/or one or more of client applications 122, 124, 126, 128. In some implementations, data analysis application 120 may be a standalone application, or may be an applet/application/script/extension that may interact with and/or be executed within rules process 110, a component of rules process 110, and/or one or more of client applications 122, 124, 126, 128. In some implementations, one or more of client applications 122, 124, 126, 128 may be a standalone application, or may be an applet/ application/script/extension that may interact with and/or be executed within and/or be a component of rules process 110 and/or data analysis application 120. Examples of client applications 122, 124, 126, 128 may include, but are not limited to, e.g., a VR application, XR or MR application, an AR application, an automatic speech recognition (ASR) application, examples of which may include, but are not limited to, e.g., an automatic speech recognition (ASR) application (e.g., modeling, transcription, etc.), a natural language understanding (NLU)/natural language processing (NLP) application (e.g., machine learning, intent discovery, etc.), a text to speech (TTS) application (e.g., context awareness, learning, etc.), a speech signal enhancement (SSE) application (e.g., multi-zone processing/beamforming, noise suppression, etc.), a voice biometrics/wake-up-word processing application, a predictive analytics application, a machine learning application, an automated underwriting system application, a risk assessment application, a fraud detection application, a customer segmentation and profiling application, a data integration and processing application, a web conferencing application, a video conferencing application, a telephony application, a voice-over-IP application, a video-over-IP application, an Instant Messaging (IM)/“chat” application, a chatbot application, an interactive voice response (IVR) application, a short messaging service (SMS)/multimedia messaging service (MMS) application, or other application that allows for AI based analysis and/or decision making, a standard and/or mobile web browser, an email application (e.g., an email client application), a textual and/or a graphical user interface, a customized web browser, a plugin, an Application Programming Interface (API), or a custom application. The instruction sets and subroutines of client applications 122, 124, 126, 128, which may be stored on storage devices 130, 132, 134, 136, may be executed by one or more processors and one or more memory architectures incorporated into client electronic devices 138, 140, 142, 144.

In some implementations, one or more of storage devices 130, 132, 134, 136, may include but are not limited to: hard disk drives; flash drives, tape drives; optical drives; RAID arrays; random access memories (RAM); and read-only memories (ROM). Examples of client electronic devices 138, 140, 142, 144 (and/or computer 112) may include, but are not limited to, a personal computer (e.g., client electronic device 138), a laptop computer (e.g., client electronic device 140), a smart/data-enabled, cellular phone (e.g., client electronic device 142), a notebook computer (e.g., client electronic device 144), a tablet, a server, a television, a smart television, a smart speaker, an Internet of Things (IoT) device, a media (e.g., audio/video, photo, etc.) capturing and/or output device, an audio input and/or recording device (e.g., a handheld microphone, a lapel microphone, an embedded microphone/speaker (such as those embedded within eyeglasses, smart phones, tablet computers, smart televisions, smart speakers, watches, etc.), an infotainment device (e.g., such as those found in vehicles combining information and/or entertainment with optional screens and/or audio for such things as navigation, multimedia, connectivity, voice control, smartphone integration, touchscreen interface, internet and apps, rear-seat entertainment, etc.), a dedicated network device, and combinations thereof. Client electronic devices 138, 140, 142, 144 may each execute an operating system, examples of which may include but are not limited to, Android™, Apple® iOS®, Mac® OS X®; Red Hat® Linux®, Windows® Mobile, Chrome OS, Blackberry OS, Fire OS, or a custom operating system.

In some implementations, one or more of client applications 122, 124, 126, 128 may be configured to effectuate some or all of the functionality of rules process 110 (and vice versa). Accordingly, in some implementations, rules process 110 may be a purely server-side application, a purely client-side application, or a hybrid server-side/ client-side application that is cooperatively executed by one or more of client applications 122, 124, 126, 128 and/or rules process 110.

In some implementations, one or more of client applications 122, 124, 126, 128 may be configured to effectuate some or all of the functionality of data analysis application 120 (and vice versa). Accordingly, in some implementations, data analysis application 120 may be a purely server-side application, a purely client-side application, or a hybrid server-side / client-side application that is cooperatively executed by one or more of client applications 122, 124, 126, 128 and/or data analysis application 120. As one or more of client applications 122, 124, 126, 128, rules process 110, and data analysis application 120, taken singly or in any combination, may effectuate some or all of the same functionality, any description of effectuating such functionality via one or more of client applications 122, 124, 126, 128, rules process 110, data analysis application 120, or combination thereof, and any described interaction(s) between one or more of client applications 122, 124, 126, 128, rules process 110, data analysis application 120, or combination thereof to effectuate such functionality, should be taken as an example only and not to limit the scope of the disclosure.

In some implementations, one or more of users 146, 148, 150, 152 may access computer 112 and rules process 110 (e.g., using one or more of client electronic devices 138, 140, 142, 144) directly through network 114 or through network 118. Further, computer 112 may be connected to network 114 through network 118, as illustrated with phantom link line 154. Rules process 110 may include one or more user interfaces, such as browsers and textual or graphical user interfaces, through which users 146, 148, 150, 152 may access rules process 110.

In some implementations, the various client electronic devices may be directly or indirectly coupled to network 114 (or network 118). For example, client electronic device 138 is shown directly coupled to network 114 via a hardwired network connection. Further, client electronic device 144 is shown directly coupled to network 118 via a hardwired network connection. Client electronic device 140 is shown wirelessly coupled to network 114 via wireless communication channel 156 established between client electronic device 140 and wireless access point (i.e., WAP 158), which is shown directly coupled to network 114. WAP 158 may be, for example, an IEEE 802.11a, 802.11b, 802.11g, 802.11n, 802.11ac, Wi-Fi®, RFID, and/or Bluetooth™ (including Bluetooth™ Low Energy) or any device that is capable of establishing wireless communication channel 156 between client electronic device 140 and WAP 158 (e.g., Zigbee, Z-Wave, etc.). Client electronic device 142 is shown wirelessly coupled to network 114 via wireless communication channel 160 established between client electronic device 142 and cellular network/bridge 162, which is shown by example directly coupled to network 114.

In some implementations, some or all of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. Bluetooth™ (including Bluetooth™ Low Energy) is a telecommunications industry specification that allows, e.g., mobile phones, computers, smart phones, and other electronic devices to be interconnected using a short-range wireless connection. Other forms of interconnection (e.g., Near Field Communication (NFC)) may also be used. In some implementations, computer 112 may be directed or controlled by an operator. Computer 112 may be hosted by one or more of assets owned by the operator, assets leased by the operator, and third-party assets. The assets may be referred to as a private, community, or hybrid cloud computing network or cloud computing environment. For example, computer 112 may be partially or fully hosted by a third-party offering software as a service (SaaS), platform as a service (PaaS), and/or infrastructure as a service (IaaS). Computer 112 may be implemented using agile development and operations (DevOps) principles. In some implementations, some or all of computer 112 may be implemented in a multiple-environment architecture. For example, the multiple environments may include one or more production environments, one or more integration environments, one or more development environments, etc.

In some implementations, various I/O requests (e.g., I/O request 115) may be sent from, e.g., client applications 122, 124, 126, 128 to, e.g., computer 112 (and vice versa). Examples of I/O request 115 may include but are not limited to, data write requests (e.g., a request that content be written to computer 112) and data read requests (e.g., a request that content be read from computer 112). Client electronic devices 138, 140, 142, 144 and/or computer 112 may also communicate audibly using an audio codec, which may receive spoken information from a user and convert it to usable digital information. An audio codec may likewise generate audible sound for a user, such as through a speaker, e.g., in a handset of a client electronic device. Such sound may include sound from voice telephone calls, may include recorded sound (e.g., voice messages, music files, etc.) and may also include sound generated by applications operating on the client electronic devices.

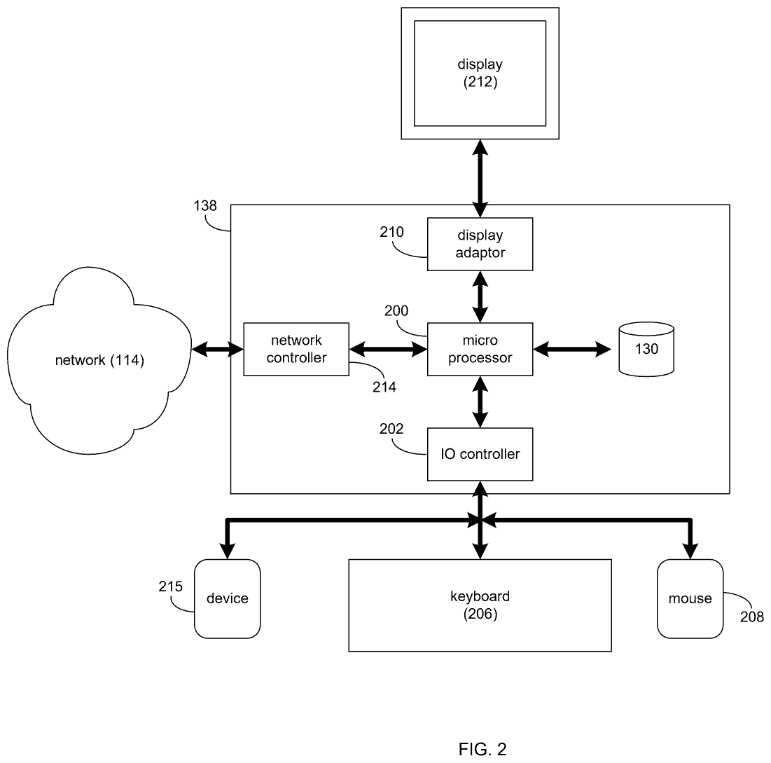

Referring also to the example implementation of FIG. 2, there is shown a diagrammatic view of client electronic device 138. While client electronic device 138 is shown in this figure, this is for example purposes only and is not intended to be a limitation of this disclosure, as other configurations are possible. Additionally, any computing device capable of executing, in whole or in part, rules process 110 may be substituted for client electronic device 138 (in whole or in part) within FIG. 2, examples of which may include but are not limited to computer 112 and/or one or more of client electronic devices 140, 142, 144.

In some implementations, client electronic device 138 may include a processor (e.g., microprocessor 200) configured to, e.g., process data and execute the above-noted code/instruction sets and subroutines. Microprocessor 200 may be coupled via a storage adaptor to the above-noted storage device(s) (e.g., storage device 130). An I/O controller (e.g., I/O controller 202) may be configured to couple microprocessor 200 with various devices (e.g., via wired or wireless connection), such as keyboard 206, pointing/selecting device (e.g., touchpad, touchscreen, mouse 208, etc.), scanner, custom device (e.g., device 215), USB ports, and printer ports. A display adaptor (e.g., display adaptor 210) may be configured to couple display 212 (e.g., touchscreen monitor(s), plasma, CRT, or LCD monitor(s), etc.) with microprocessor 200, while network controller/adaptor 214 (e.g., an Ethernet adaptor) may be configured to couple microprocessor 200 to network 114 (e.g., the Internet or a local area network).

A rules engine, such as a Business Rules Engine (BRE), typically allows users to configure and execute complex rules (e.g., business rules) pertaining to various applications. For instance, when referring to a Premium Finance Line of business, the decision making and funding of the Premium Finance contracts may be automated with minimal or no human intervention. Data from Premium Finance Agreements (PFAs) may be read through various AI-based APIs and used for automated decision making of loan processing. Unfortunately, PFA documents, like other types of documents, are read by business users for key data elements, and they are fed into a system for loan processing. Additionally, these rules are directly embedded in the application code. Due to hardcoded business rules in the code, implementing a change to a rule is a cumbersome effort that involves multiple development and testing cycles, and it is a time-consuming affair requiring specific expertise. Thus, users cannot create or change a business rule independently without involving software development and testing teams, which is why review of PFAs and entering key data elements by business users are done manually.

Therefore, as will be discussed in greater detail below, the present disclosure describes a rules engine framework allows users to create rules as expressions in readable plain English (or other native language) text with logical operators (e.g., greater than, less than, greater than or equal to, less than or equal to, equal to, not equal to etc.). In some implementations, multiple rules may be chained together as a RuleSet, with conditional operators like AND, OR with order of evaluation. Using these rules, an API (e.g., an AI-based API) may be used to extract key data elements automatically from a PFA, for automated loan processing. It will be appreciated that while loans are being discussed, other financial applications, as well as non-financial applications, may also be used without departing from the scope of the present disclosure. As such, the use of any financial application should be taken as example only and not to otherwise limit the scope of the present disclosure.

As will be discussed below, rules process 110 may at least help, e.g., improve data extraction and/or analysis functions, necessarily rooted in computer technology, in order to overcome an example and non-limiting problem specifically arising in the realm of computers and improve existing technological processes associated with, e.g., creating and managing rules for a rules engine. It will be appreciated that the computer processes described throughout are integrated into one or more practical applications, and when taken at least as a whole are not considered to be well-understood, routine, and conventional functions.

### The Rules Process

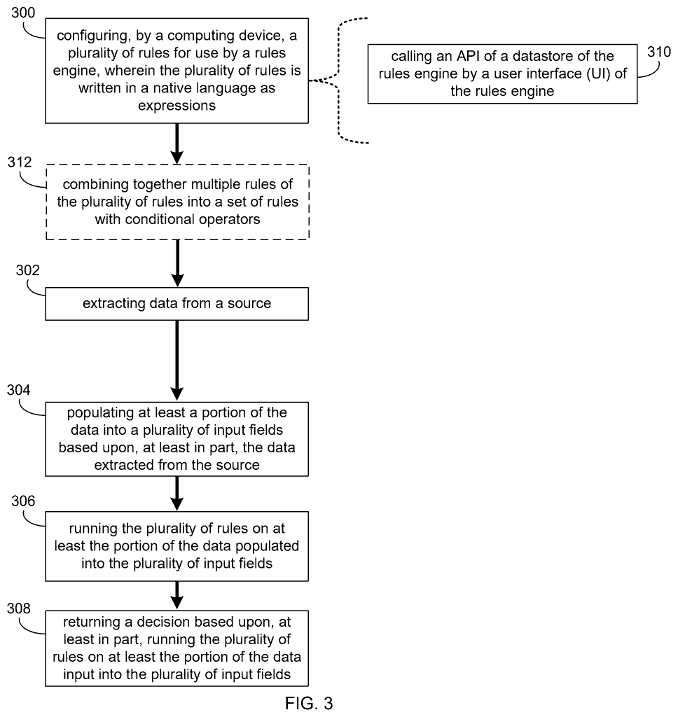

As discussed above and referring also at least to the example implementations of FIGS. 3-8, rules process 110 may configure 300, by a computing device, a plurality of rules for use by a rules engine, wherein the plurality of rules may be written in a native language as expressions. Rules process 110 may extract 302 data from a source. Rules process 110 may input 304 at least a portion of the data into a plurality of input fields based upon, at least in part, the data extracted from the source. Rules process 110 may run 306 the plurality of rules on at least the portion of the data populated into the plurality of input fields. Rules process 110 may return 308 a decision based upon, at least in part, running the plurality of rules on at least the portion of the data populated into the plurality of input fields.

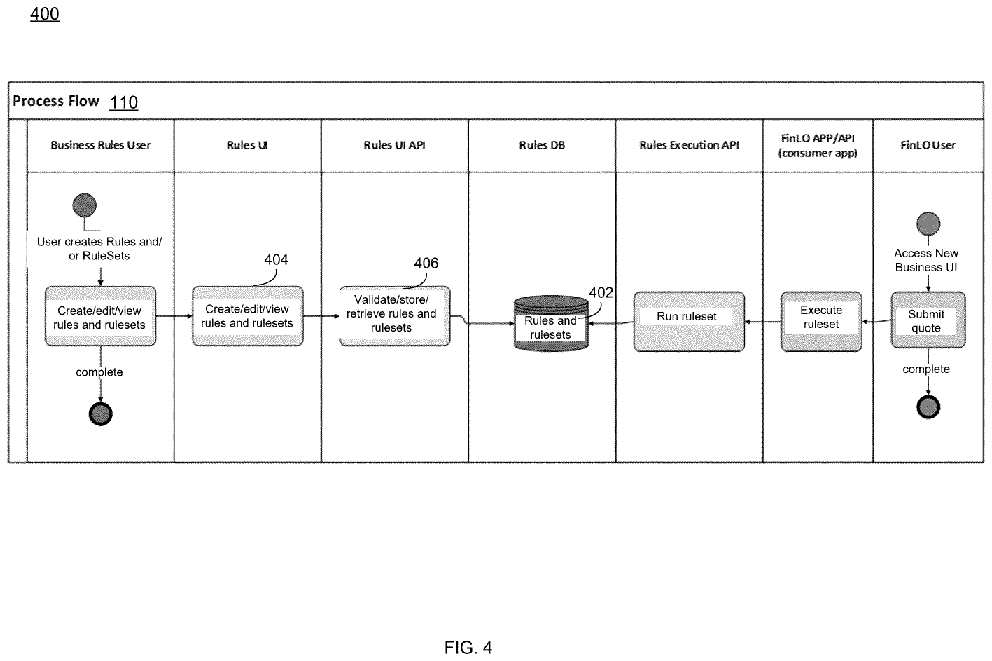

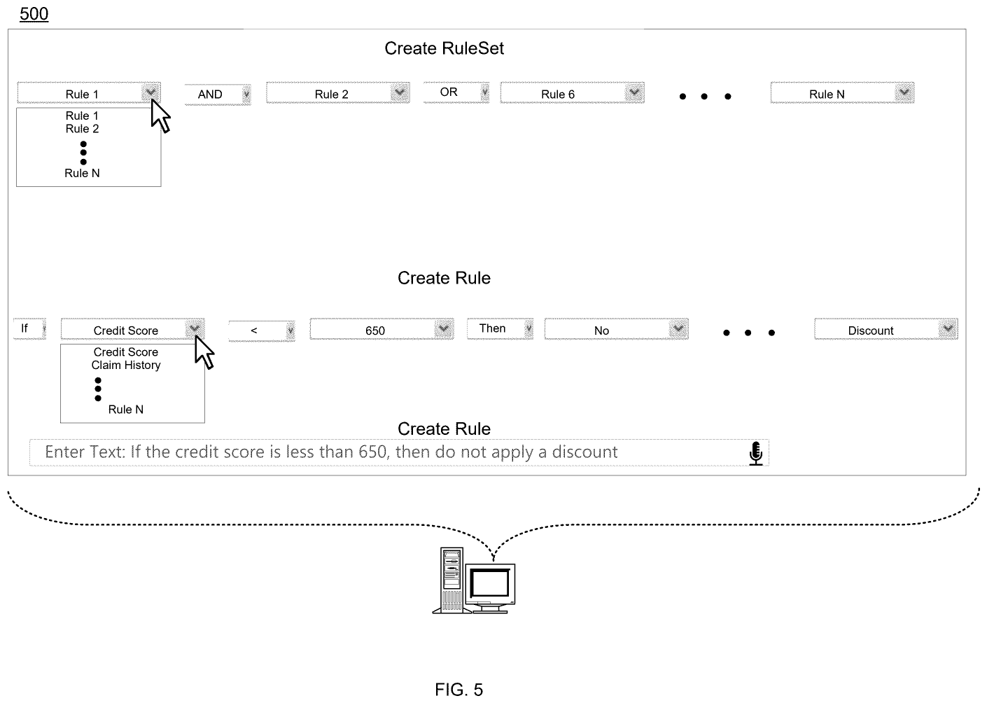

In some implementations, rules process 110 may configure 300, by a computing device (e.g., client electronic device 138), a plurality of rules for use by a rules engine, wherein the plurality of rules may be written in a native language as expressions (e.g., Expression 1: AgentCode==“AGT001”; Expression 2: AgentStage==“Florida”; Expression 3: CustomerPhoneNumber!=“911”; etc.). For example, and referring also to the example implementation of FIG. 4, an example process flow diagram 400 is shown. In the example, rules process 110 may run a user interface (UI) to enable a user to configure a plurality of rules for use by a rules engine (e.g., rules process 110), as explained in more detail in FIG. 5 below. In some implementations, the rules (e.g., rules 402) may be stored in a data store, such as the data store of storage device 116 from FIG. 1.

In some implementations, configuring the plurality of rules for use by the rules engine may include calling 310 an Application Programming Interface (API) of a data store of the rules engine by a user interface (UI) of the rules engine. For example, rules process 110 may include a rule UI (e.g., rules UI 404). In the example, UI 404 of rules process 110 may interact with the data store through an API to manage and execute business rules. Users, such as business analysts or administrators, may utilize the UI to create, modify, delete, or query business rules. For instance, an analyst might log into a rules engine dashboard to update the eligibility criteria for a loan application. When the analyst performs this action, rules UI 404 may send a request (e.g., an HTTP request) to the rules engine's API (e.g., rules API 406), such as a PUT request to update a rule. API 406, which may be built using known frameworks, receives this request and processes it by performing necessary validation and authorization checks to ensure the request is legitimate. Once validated, rules API 406 interacts with the database—whether it's a SQL database like PostgreSQL or MySQL, or a NoSQL database like MongoDB—to execute the required operation. For example, rules API 406 may execute an SQL UPDATE query or a MongoDB updateOne operation to modify the rule. After completing the database operation, rules API 406 may send a response back to UI 404, indicating whether the operation was successful or if it failed. UI 404 may then update the user interface accordingly, displaying a success message, refreshing the list of rules, or updating the rule's status to reflect the changes.

In some implementations, the validation and authorization checks may ensure that the operations are legitimate and secure. In prior systems where the rules were hardcoded into the application and thus requires a detailed cumbersome effort that involves multiple development and testing cycles requiring specific expertise, validation checks may include input data validation, where rules process 110 verifies that the data provided by the user meets the expected format, type, and constraints, such as ensuring rule names are non-empty strings and dates are correctly formatted. Schema validation ensures that the data adheres to the predefined schema, confirming that all required fields are present and structured correctly. Business logic validation checks that the data makes sense within the business context, such as ensuring a discount percentage does not exceed 100%. Cross-field validation ensures that related fields are consistent, for example, verifying that the end date of a rule is not before the start date. In some implementations, the input and data type may be configured by the Business rules user interface. Based on this configuration, the rules engine may perform runtime validation of input elements against the above-noted expressions. However, as will be discussed in greater detail below, such validation is not required at the user level and is abstracted to a lower level transparent to the user.

In some implementations, authorization checks begin with authentication, where rules process 110 verifies the identity of the user through mechanisms like token-based authentication. Example authorizations may include Role-Based Access Control (RBAC) that ensures that the user has the appropriate permissions to perform the requested action, such as allowing only admins to create or delete rules while read-only users can only view them. Another example is resource-based authorization that checks if the user has permission to access or modify the specific resource they are requesting, such as editing rules within their department. Another example is contextual authorization that ensures the action is permissible within the current context, such as allowing modifications only during business hours. These layered checks ensure that only authenticated and authorized users can perform actions, maintaining integrity and security.

In some implementations, the rules are not hardcoded in an underlying codebase of the rules engine and the plurality of rules may be modifiable without changing an underlying codebase of the rules engine. For instance, if rules are not hardcoded in the application code, it means the logic, conditions, or parameters governing the application's behavior are defined and managed externally, providing several advantages. This approach enhances flexibility and adaptability, allowing business logic and rules to be updated without altering the underlying codebase. For instance, an insurance application can update underwriting criteria in response to market changes without redeploying the software and needing software coders. It also simplifies maintenance, as updates to rules can be made through configuration files, databases, or rule management systems without requiring developers to modify complex code. This separation of concerns enables business analysts or domain experts to manage rules while developers focus on technical implementation. Additionally, externalizing rules improves testing and validation, allowing rules to be tested independently of the application code. Dynamic rule changes become possible, allowing updates at runtime without restarting or redeploying the application, which is beneficial for high-availability systems. Furthermore, this approach enhances reusability, enabling the same set of rules to be used across multiple applications or services, ensuring consistency and reducing redundancy. Overall, externalizing rules allows applications to adapt quickly to changing requirements, simplifies the management of complex business logic, and promotes efficient and flexible development practices.

In some implementations, rules process 110 may combine 312 together multiple rules of the plurality of rules into a set of rules with conditional operators. For example, and referring at least to the example implementation of FIG. 5, an example UI 500 of rules process 110 enabling the creation of individual rules, as well as the combining of rules is shown. In the example, rules process 110 may enable a user to create rules using drop down menus, as well as using natural language. In the example, rules process 110 may enable a user to combine rules together (e.g., via a drop down menu) to create a ruleset (set of rules) with conditional operators (e.g., via a drop down menu), which may involve defining a set of individual rules and specifying how they interact using logical operators such as AND, OR, and NOT. Each individual rule may represent a specific condition or criterion, like a customer's age, credit score, or claim history. For instance, Rule 1 could state that a customer's age must be over 25, Rule 2 might require the customer to have a credit score above 700, and Rule 3 could specify that the customer must have no claims in the past five years. Conditional operators are then used to combine these rules, creating complex decision-making criteria. For example, the AND operator ensures that all combined rules must be true for the ruleset to be satisfied, such as needing to meet Rule 1 AND Rule 2 AND Rule 3 to qualify for a premium discount. The OR operator requires at least one rule to be true, like satisfying either Rule 1 OR Rule 2 to qualify for a basic discount. The NOT operator negates a rule, making the condition true if the rule is not satisfied, such as applying a surcharge if the customer does NOT have a high credit score. These operators can be nested to form more intricate conditions, allowing for comprehensive and nuanced rulesets. For example, a special discount might require the customer to either be over 25 years old with a high credit score or have no claims in the past five years but not be over 60 years old, expressed as (Rule 1 AND Rule 2) OR (Rule 3 AND NOT (customer's age >60)). These combined rules may then be implemented in the rules engine of rules process 110, which defines and evaluates the ruleset against incoming data. When processing an insurance application, the rules engine checks the applicant's age, credit score, and claim history against the ruleset to decide on the discount eligibility. Based on the outcome, appropriate actions are taken, such as applying the discount if the criteria are met. This method enables the creation of detailed and dynamic rulesets that can adapt to various scenarios and requirements, facilitating efficient and flexible decision-making.

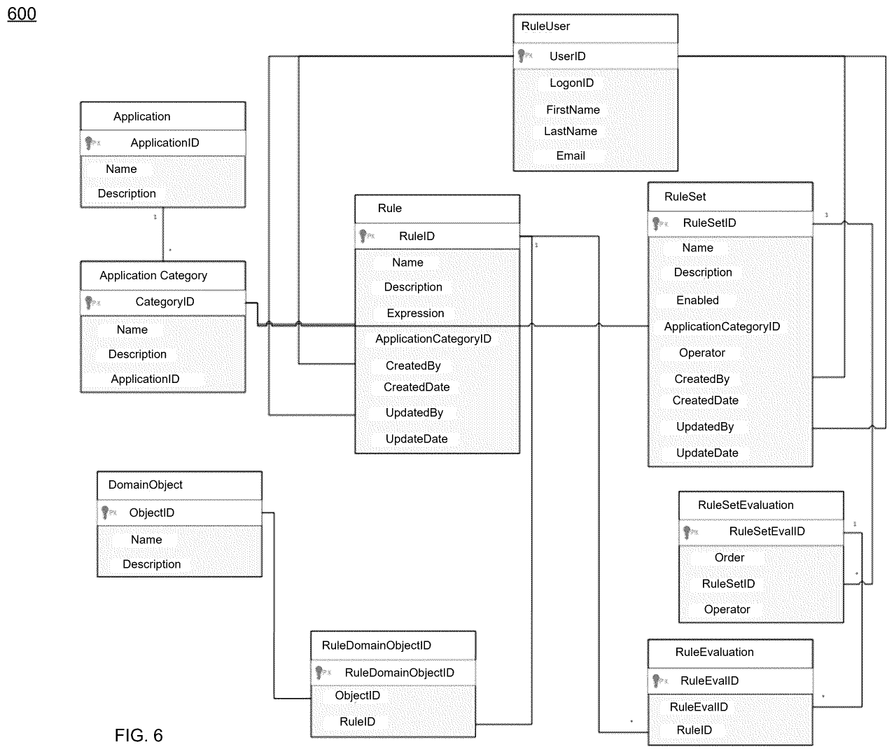

Referring at least to the example implementation of FIG. 6, an example logical data model 600 of the rules engine of rules process 110 is shown. In the example, the logical data model is an abstraction of the rules created from FIG. 5 that is readable by the system. Each rule may be associated with various information, such as, e.g., the application being reviewed, the application category, the rule, the rule set, the rule user, the domain object, the rule evaluation, the ruleset evaluation, and the rule domain objectID, etc. In some implementations, these options, as well as other options and categories, may be available for selection in FIG. 5, or matched to the user's natural language input (e.g., via text or ASR), and may be created based on the inputs of FIG. 5.

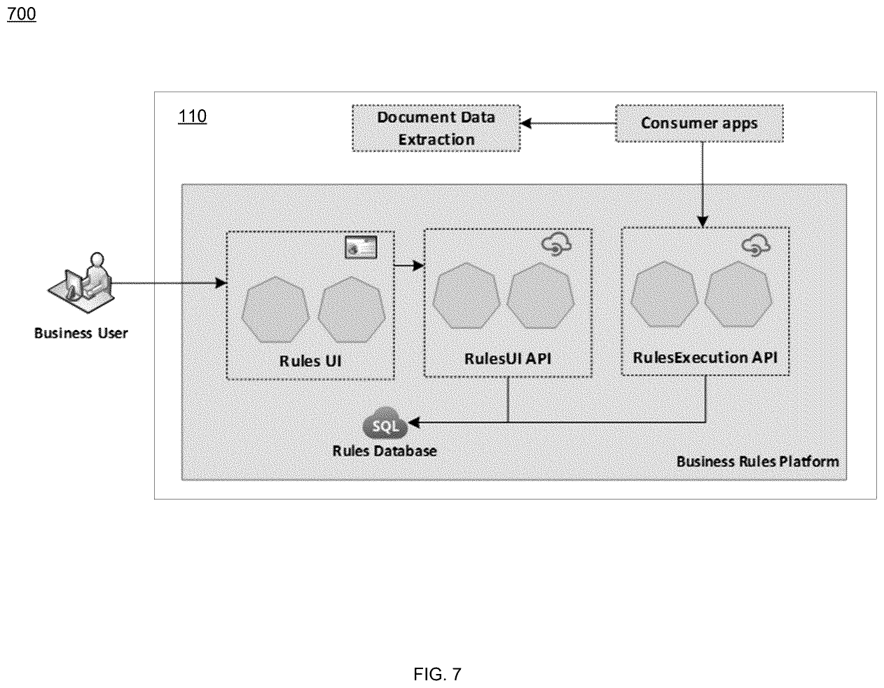

In some implementations, rules process 110 may extract 302 data from a source, and in some implementations, the API of the rules engine may extract the data from the source. For instance, and referring at least to the example implementation of FIG. 7, an example, high level logical architecture diagram 700 of rules process 110 is shown. In the example, the API of rules process 110 may extract data from documents (or other data) in the database through a systematic process involving request handling, database connection, query construction, data retrieval, data transformation, rule evaluation, response construction, and response delivery. When a client application (e.g., via rules process 110) sends a request to the API, such as evaluating insurance eligibility for a customer, it may include specific parameters like customer/application ID or policy type. The API then establishes a connection to the database, utilizing database drivers or ORM tools for efficient access. In the example, rules process 110 may construct a query based on the request parameters, for instance, a SQL query SELECT*FROM customers WHERE customer_id=? for a SQL database or {“customer_id”: customerId} for a NoSQL database like MongoDB, specifying which documents or data fields to retrieve. In some implementations, the query may be executed against the database, and the required data is retrieved. This data may be transformed into a structured format, such as JSON, suitable for the rules engine. For example, database records may be converted into a JSON object containing customer information. The rules engine then evaluates the transformed data against the defined ruleset to determine outcomes, such as eligibility for an insurance discount. For instance, it checks if the customer's age is over 25, their credit score is above 700, and they have no claims in the past five years. After evaluation, the API constructs a response based on the results, like indicating whether the customer is eligible for a discount and the amount. Finally, the API sends the constructed response, formatted as a JSON object, back to the client application. This process ensures efficient data extraction, accurate rule evaluation, and seamless integration between the database and the rules engine.

In some implementations, rules process 110 may input 304 at least a portion of the data into a plurality of input fields based upon, at least in part, the data extracted from the source. For example, once rules process 110 has extracted data from the database, it maps this data to the corresponding input fields required for rules evaluation. For instance, if the extracted data is in a JSON format containing fields such as {“customer_id”: 123, “age”: 30, “credit_score”: 750, “no_claims”: true}, the rules engine will map these fields to input variables like input_customer_id, input_age, input_credit_score, and input_no_claims. Rules process 110 may then assign the values from the JSON object to these input fields, setting input_customer_id to 123, input_age to 30, input_credit_score to 750, and input_no_claims to true.

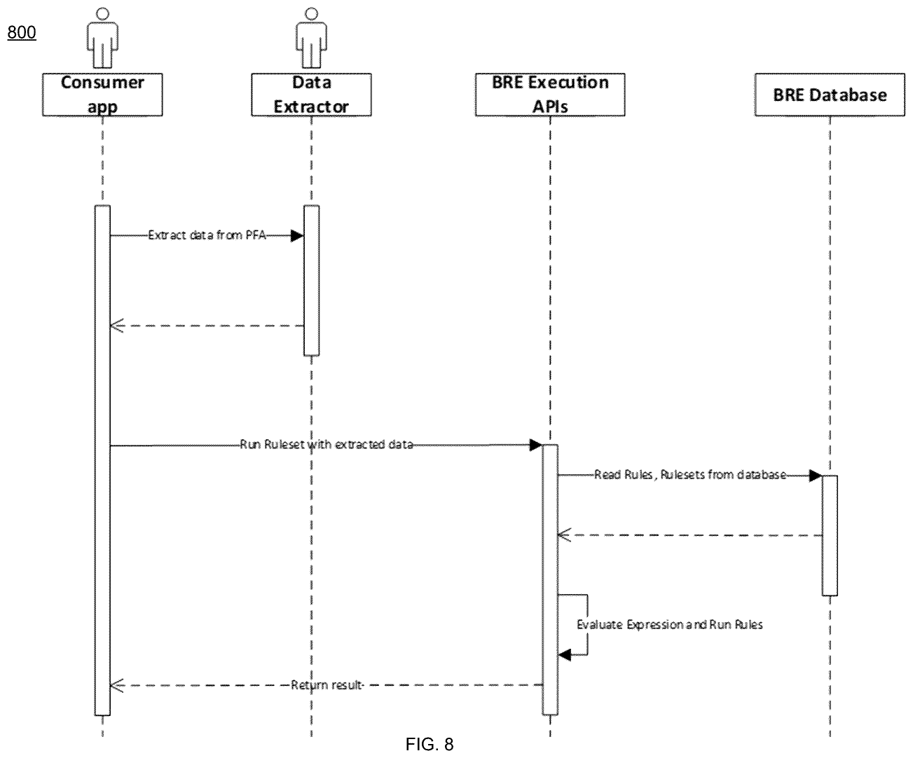

In some implementations, rules process 110 may run 306 the plurality of rules on at least the portion of the data populated into the plurality of input fields, and in some implementations, rules process 110 may return 308 a decision based upon, at least in part, running the plurality of rules on at least the portion of the data populated into the plurality of input fields. For instance, and referring at least to the example implementation of FIG. 8, an example workflow 800 shows a sequence of interactions that occur when consuming application calls Document Data extraction API to retrieve data and rules engine to execute rules. For example, with the above-noted input fields properly assigned to the extracted data, rules process 110 may evaluate the ruleset. For example, rules determining an insurance discount might check if input_age is greater than 25, if input_credit_score is above 700, and if input_no_claims is true. Based on this evaluation, rules process 110 may execute the appropriate actions, such as calculating a discount if all conditions are met. Rules process 110 may generate an output based on the evaluation results, such as {“eligible_for_discount”: true, “discount_amount”: 10}, and construct the final response. This process ensures that the extracted data is accurately placed into the proper input fields, maintaining data integrity and leading to reliable decision-making.

In some implementations, an expression tree may evaluate and execute the expressions. For example, instead of a straightforward procedural evaluation, the rules may be represented as an expression tree (e.g., in the .NET framework). An expression tree may be described as a hierarchical structure where each node represents an operation (like AND, OR, NOT) or an operand (like specific values or variables). For instance, a rule might be represented as an expression tree with nodes for conditions like input_age >25 AND input_credit_score >700 AND input_no_claims==true. During the evaluation, rules process 110 traverses this expression tree. Starting from the root node, it evaluates each sub-expression by recursively evaluating its child nodes. If a node represents an operation, the engine evaluates its operands (child nodes) and applies the operation. For example, for the root node representing an AND operation, it would evaluate whether both child nodes (input_age>25 and input_credit_score>700) are true. The results of these evaluations determine the outcome of the rule. If all conditions are satisfied, the expression tree evaluation returns true, triggering the corresponding action, such as calculating a discount. The final output, based on the expression tree's evaluation, might be a JSON object like {“eligible_for_discount”: true, “discount_amount”: 10}, which the rules engine then sends as the response. Using an expression tree allows for more dynamic and flexible rule evaluation, particularly when dealing with complex, nested conditions. It also facilitates optimizations such as short-circuit evaluation, where the engine can stop evaluating as soon as it determines the overall expression's outcome. This ensures efficient, accurate decision-making based on the structured data input.

In some implementations, rules process 110 may include an AI-based document model that may be trained to extract data for automatic decisioning of loans. First, a diverse set of loan-related documents, such as loan applications, financial statements, tax returns, pay stubs, bank statements, and credit reports, may be collected and annotated with relevant labels identifying key information such as the applicant's name, income, credit score, and loan amount requested. These documents may then be preprocessed using Optical Character Recognition (OCR) to convert them into machine-readable text, followed by cleaning to remove noise and normalizing the data for consistency. The text may be tokenized into words and phrases, which the AI model can process. Key features necessary for loan decisioning are identified, and training features are developed to help the model learn to recognize these features. In some implementations, pre-trained models suitable for natural language processing and document understanding may be selected and fine-tuned on the annotated dataset to adapt them to the specific context of loan document analysis. The models are trained using the labeled data, employing techniques like supervised learning, and their performance is evaluated using metrics such as precision, recall, F1 score, and accuracy. This process may include error analysis to identify common mistakes and iteratively improve the model. Once trained, the models are integrated into rules process 110 through APIs, enabling automated extraction and decision-making. In some implementations, a feedback loop may be established where human reviews of the model's predictions provide additional labeled data for retraining, ensuring continuous improvement and adaptation to evolving document formats and criteria. This comprehensive approach ensures that AI-based document models can effectively automate the extraction of critical information from loan documents, enhancing the accuracy and efficiency of the loan decision-making process.

The terminology used herein is for the purpose of describing particular implementations only and is not intended to be limiting of the disclosure. As used herein, the singular forms “a”, “an” and “the” are intended to include the plural forms as well, including any steps performed by a/the computer/processor, unless the context clearly indicates otherwise. As used herein, the phrase “at least one of A, B, and C” should be construed to mean a logical (A OR B OR C), using a non-exclusive logical OR, and should not be construed to mean “at least one of A, at least one of B, and at least one of C. ” As another example, the language “at least one of A and B” (and the like) as well as “at least one of A or B” (and the like) should be interpreted as covering only A, only B, or both A and B, unless the context clearly indicates otherwise. It will be further understood that the terms “comprises” and/or “comprising,” when used in this specification, specify the presence of stated features, integers, steps (not necessarily in a particular order), operations, elements, and/or components, but do not preclude the presence or addition of one or more other features, integers, steps (not necessarily in a particular order), operations, elements, components, and/or groups thereof. Example sizes/models/values/ranges can have been given, although examples are not limited to the same.

The terms (and those similar to) “coupled,” “attached,” “connected,” “adjoining,” “transmitting,” “communicating,” “receiving,” “connected,” “engaged,” “adjacent,” “next to,” “on top of,” “above,” “below,” “abutting,” and “disposed,” used herein is to refer to any type of relationship, direct or indirect, between the components in question, and may apply to electrical, mechanical, fluid, optical, electromagnetic, electromechanical or other connections, including logical connections via intermediate components (e.g., device A may be coupled to device C via device B). Additionally, the terms “first,” “second,” etc. are used herein only to facilitate discussion, and carry no particular temporal or chronological significance unless otherwise indicated. The terms “cause” or “causing” means to make, force, compel, direct, command, instruct, and/or enable an event or action to occur or at least be in a state where such event or action is to occur, either in a direct or indirect manner. The term “set” does not necessarily exclude the empty set—in other words, in some circumstances a “set” may have zero elements. The term “non-empty set” may be used to indicate exclusion of the empty set—that is, a non-empty set must have one or more elements, but this term need not be specifically used. The term “subset” does not necessarily require a proper subset. In other words, a “subset” of a first set may be coextensive with (equal to) the first set. Further, the term “subset” does not necessarily exclude the empty set—in some circumstances a “subset” may have zero elements.

The corresponding structures, materials, acts, and equivalents (e.g., of all means or step plus function elements) that may be in the claims below are intended to include any structure, material, or act for performing the function in combination with other claimed elements as specifically claimed. While the disclosure describes structures corresponding to claimed elements, those elements do not necessarily invoke a means plus function interpretation unless they explicitly use the signifier “means for.” Unless otherwise indicated, recitations of ranges of values are merely intended to serve as a shorthand way of referring individually to each separate value falling within the range, and each separate value is hereby incorporated into the specification as if it were individually recited. While the drawings divide elements of the disclosure into different functional blocks or action blocks, these divisions are for illustration only. According to the principles of the present disclosure, functionality can be combined in other ways such that some or all functionality from multiple separately-depicted blocks can be implemented in a single functional block; similarly, functionality depicted in a single block may be separated into multiple blocks. Unless explicitly stated as mutually exclusive, features depicted in different drawings can be combined consistent with the principles of the present disclosure. Moreover, although this disclosure describes and depicts respective implementations herein as including particular components, elements, feature, functions, operations, or steps (and arrangements thereof), any of these implementations may include any combination, arrangement, or permutation of any of the components, elements, features, functions, operations, or steps described or depicted anywhere herein that a person having ordinary skill in the art would comprehend after reading the present disclosure. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

The description of the present disclosure has been presented for purposes of illustration and description but is not intended to be exhaustive or limited to the disclosure in the form disclosed. After reading the present disclosure, many modifications, variations, substitutions, and any combinations thereof will be apparent to those of ordinary skill in the art without departing from the scope and spirit of the disclosure. The implementation(s) were chosen and described in order to explain the principles of the disclosure and the practical application, and to enable others of ordinary skill in the art to understand the disclosure for various implementation(s) with various modifications and/or any combinations of implementation(s) as are suited to the particular use contemplated. The features of any dependent claim may be combined with the features of any of the independent claims or other dependent claims.

Having thus described the disclosure of the present application in detail and by reference to implementation(s) thereof, it will be apparent that modifications, variations, and any combinations of implementation(s) (including any modifications, variations, substitutions, and combinations thereof) are possible without departing from the scope of the disclosure defined in the appended claims.

What is claimed is:

1. A computer-implemented method, comprising:
configuring a plurality of rules, written in a native language as expressions, for use by a rules engine;
extracting data from a source;
populating at least a portion of the data into a plurality of input fields based upon, at least in part, the data extracted from the source;
running the plurality of rules on at least the portion of the data populated into the plurality of input fields; and
returning a decision based upon, at least in part, running the plurality of rules on at least the portion of the data populated into the plurality of input fields.

2. The computer-implemented method of claim 1, further comprising combining together multiple rules of the plurality of rules into a set of rules with conditional operators.

3. The computer-implemented method of claim 1, wherein the rules are not hardcoded in an underlying codebase of the rules engine.

4. The computer-implemented method of claim 1, wherein the plurality of rules is modifiable without changing an underlying codebase of the rules engine.

5. The computer-implemented method of claim 1, wherein an expression tree evaluates and executes the expressions.

6. The computer-implemented method of claim 1, wherein configuring the plurality of rules for use by the rules engine includes calling an Application Programming Interface (API) of a data store of the rules engine by a user interface (UI) of the rules engine.

7. The computer-implemented method of claim 6, wherein the API of the rules engine extracts the data from the source.

8. A computer program product residing on a computer readable storage medium having a plurality of instructions stored thereon which, when executed across one or more processors, causes at least a portion of the one or more processors to perform operations comprising:
configuring a plurality of rules, written in a native language as expressions, for use by a rules engine;
extracting data from a source;
populating at least a portion of the data into a plurality of input fields based upon, at least in part, the data extracted from the source;
running the plurality of rules on at least the portion of the data populated into the plurality of input fields; and
returning a decision based upon, at least in part, running the plurality of rules on at least the portion of the data populated into the plurality of input fields.

9. The computer program product of claim 8, wherein the operations further comprise combining together multiple rules of the plurality of rules into a set of rules with conditional operators.

10. The computer program product of claim 8, wherein the rules are not hardcoded in an underlying codebase of the rules engine.

11. The computer program product of claim 8, wherein the plurality of rules are modifiable without changing an underlying codebase of the rules engine.

12. The computer program product of claim 8, wherein an expression tree evaluates and executes the expressions.

13. The computer program product of claim 8, wherein configuring the plurality of rules for use by the rules engine includes calling an Application Programming Interface (API) of a data store of the rules engine by a user interface (UI) of the rules engine.

14. The computer program product of claim 13, wherein the API of the rules engine extracts the data from the source.

15. A computing system including one or more processors and one or more memories configured to perform operations comprising:
configuring a plurality of rules, written in a native language as expressions, for use by a rules engine;
extracting data from a source;
populating at least a portion of the data into a plurality of input fields based upon, at least in part, the data extracted from the source;
running the plurality of rules on at least the portion of the data populated into the plurality of input fields; and
returning a decision based upon, at least in part, running the plurality of rules on at least the portion of the data populated into the plurality of input fields.

16. The computing system of claim 15, wherein the operations further comprise combining together multiple rules of the plurality of rules into a set of rules with conditional operators.

17. The computing system of claim 15, wherein the rules are not hardcoded in an underlying codebase of the rules engine.

18. The computing system of claim 15, wherein the plurality of rules are modifiable without changing an underlying codebase of the rules engine.

19. The computing system of claim 15, wherein an expression tree evaluates and executes the expressions.

20. The computing system of claim 15, wherein:
configuring the plurality of rules for use by the rules engine includes calling an Application Programming Interface (API) of a data store of the rules engine by a user interface (UI) of the rules engine, and
the API of the rules engine extracts the data from the source.
